(19) United States
(12) Patent Application Publication
(10) Pub. No.: US 2021/0404811 A1
(43) Pub. Date: Dec. 30, 2021

(54) METHOD FOR SOLVING ATTITUDE OF RIGID BODY BASED ON FUNCTION ITERATIVE INTEGRATION

(71) Applicant: SHANGHAI JIAO TONG UNIVERSITY, Shanghai (CN)

(72) Inventors: Yuanxin WU, Shanghai (CN); Wenxian YU, Shanghai (CN)

(21) Appl. No.: 17/403,864

(22) Filed: Aug. 16, 2021

Related U.S. Application Data
(63) Continuation-in-part of application No. 16/340,128, filed on Apr. 7, 2019.

(30) Foreign Application Priority Data
Apr. 21, 2017 (CN) 201710273489.3

(51) Int. Cl. G01C 21/18; G01C 19/5776; G01C 21/20

(52) U.S. Cl. CPC G01C 21/18; G01C 21/20; G01C 19/5776

(57) ABSTRACT

The present disclosure provides a system and a method for solving an attitude of a rigid body based on function iterative integration, including: step 1, fitting a polynomial function of an angular velocity according to a gyroscope measurement value over a time interval; step 2, iteratively calculating a Rodrigues vector by using the fitted polynomial function of the angular velocity and a Rodrigues vector integral equation; and Step 3, and obtaining an attitude change over the time interval in terms of quaternion according to the final iterative result of the Rodrigues vector.

### CROSS-REFERENCE TO RELATED APPLICATIONS

This application is a Continuation in Part of application Ser. No. 16/340,128. This Application claims priority from application Ser. No. 16/340,128, filed Apr. 7, 2019, the contents of which are incorporated herein in the entirety by reference.

This application is a national stage application of PCT Application No. PCT/CN2017/082317. This Application claims priority from PCT Application No. PCT/CN2017/082317, filed Apr. 28, 2017, and CN Application No. 201710273489.3, filed Apr. 21, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### TECHNICAL FIELD

The present disclosure relates to technical fields of inertial navigation, robots, etc., in particular, to a system and method for solving an attitude of a rigid body based on function iterative integration.

### BACKGROUND

Calculation or estimation of rigid body motion in a three-dimensional space is a key issue in many technical fields, such as physics, robotics, navigation guidance, machinery, and computer vision, etc. Accurate knowledge of rigid body motion would help better achieve the tasks of interest, such as navigate an airplane to its destination or guide a missile to a hostile target. Unlike the translational motions such as velocity and position, attitude cannot be directly measured, and could only be obtained in indirect ways, such as, by using angular velocity integration or vector matching. Attitude calculation based on angular velocity integration is completely autonomous, which does not need external information, and thus it is favorable in many applications (such as when the satellite navigation systems cannot work). The calculated attitude can either be used directly by an apparatus or an equipment to find the needed direction, or be used as an input for the subsequent calculation, such as velocity or position calculation. The attitude, velocity and position information are collectively known as the navigation information, which may be used to guide a number of vehicles, such as cars, airplanes, missiles and submarines, to their destinations. More accurate navigation information will guide the vehicles more effectively and efficiently.

In an inertial navigation system, a triad of gyroscopes is usually employed to measure the angular velocity or angular increment (the integrated angular velocity) of a vehicle, onto which the inertial navigation system is rigidly fixed. However, angular velocity measurements by gyroscopes would inevitably have errors, resulting in unbounded drift in the integrated attitude. In fact, it is generally held that even if the angular velocity measurements are accurate, the attitude cannot be accurately calculated due to the noncommutativity of finite rotations. The noncommutativity of finite rotations means that different sequences of finite rotations will generate different attitudes. Therefore, an approximate method has to be utilized to calculate the attitude. For instance, the noncommutativity of finite rotations is typically approximated up to the 2^{nd} or 3^{rd} order, which has been taken as the design basis of almost all attitude algorithms in the inertial navigation community. The approximation in attitude calculation poses a big problem if the attitude calculation error significantly surpasses the attitude error caused by gyroscope measurement error, for example, in an application scenario of a highly dynamic projectile or of a forthcoming highly-accurate cold-atom inertial navigation system. In other words, the attitude error would be dominated by the attitude calculation error caused by the insufficiently handled noncommutativity of finite rotations. This is a situation that any practitioner wants to avoid, because the measurements of cost-sensitive gyroscopes are compromised by the approximation in the attitude calculation.

Mainstream attitude computation methods in the field of inertial navigation usually utilized quaternion to describe the current attitude and applied the rotation vector to describe the attitude increment. In general attitude motions, the relationship between the rotation vector and the angular velocity is very complicated, and it has to be considerably simplified so as to be used in approximate methods. Mainstream attitude computation methods usually approximately estimate the rotation vector by using a plurality of angular velocity or angular increment measurements (also called ‘samples’) that are consecutively collected by the triad of gyroscopes, so only the attitude result at the last sample time can be obtained. It would not be a big problem if the attitude computation is the only one to be concerned; however, it would be quite another story when the attitude is taken as an input to the subsequent steps, such as, in the inertial navigation system, the obtained attitude needs to be used to calculate velocity and position. In addition, all the mainstream attitude computation methods are designed by using a particular motion, for example, the coning motion, as the basis for optimization; however, it would not be optimal in other motions.

Therefore, a heretofore unaddressed need exists in the art to address the aforementioned deficiencies and inadequacies.

### SUMMARY

In view of the deficiencies in the state of the art, the purpose of the present disclosure is to provide a method for computing a rigid body's attitude based on function iterative integration. The present method is based on the technology of function iterative integration, which adopts the Rodrigues vector to analytically reconstruct the attitude from the angular velocity, thanks to the polynomial form of its differential equation. The differential equation of the Rodrigues vector is much simpler than that of the rotation vector and allows the iterative integration of polynomial functions for accurate attitude reconstruction. The present disclosure is able to sufficiently handle the noncommutativity of finite rotations and drive the attitude calculation error to the level of computer truncation error. The applications whose attitude calculation error takes a significant percentage of the whole attitude error would benefit most from the present disclosure, including but not limited to highly dynamic projectiles or submarines using the forthcoming highly-accurate cold-atom inertial navigation system as a guide under the sea.

According to the method for attitude computation of a rigid body based on function iterative integration, the method includes the following steps:

Step 1, to fit a polynomial function of angular velocity according to gyroscope measurements over a time interval;

Step 2, to iteratively calculate the Rodrigues vector by using the fitted polynomial function of angular velocity and the Rodrigues vector integral equation; and

Step 3, to obtain the attitude change over the time interval in terms of quaternion according to the final iterative result of the Rodrigues vector.

Preferably, gyroscope measurements take the form of either angular velocity or angular increment.

Preferably, the Step 1 comprises:

with respect to N angular velocity measurements ωₜ_{ₖ}, k=1,2, . . . N at time tₖ, the polynomial function of angular velocity is fitted by using a polynomial of order less than N−1; or, the polynomial function of angular velocity could be alternatively fitted by the basis of the Chebyshev polynomial.

Preferably, the Step 1 comprises:

with respect to N angular increment measurements Δθₜ, k=1,2, . . . N at time tₖ, the polynomial function of angular velocity is fitted by using a polynomial of order less than N-1; or, the polynomial function of angular velocity could be alternatively fitted by the basis of the Chebyshev polynomial.

Preferably, the Step 2 comprises:

The iterative calculation is performed, by substituting the fitted polynomial function into the Rodrigues vector integral equation, until a convergence condition is satisfied or a predetermined value of maximum times of iteration is reached.

As compared with the state of the art, the present disclosure has the following advantages:
1) a new attitude computation method is proposed, which could be extended to a general rigid body motion; 2) the new attitude computation method will strictly converge to an exact attitude when the angular velocity is accurate; 3) the Rodrigues vector iteratively reconstructed from the angular velocity is in terms of analytic polynomial, and thus all the attitude over the corresponding time interval could be obtained; 4) the design of the new attitude computation method does not rely on the assumption of any special motion.

There is provided a system, including: a rigid body; and an inertial navigation system attached to the rigid body, wherein the inertial navigation system comprises a triad of gyroscopes, one or more processors, and a memory storing program instructions for calculating the attitude of the rigid body, wherein execution of the program instructions by the one or more processors causes the one or more processors to carry out the following steps:

Step 1, fitting a polynomial function of angular velocity according to gyroscope measurements, from a triad of gyroscopes, over a time interval, wherein the polynomial function of the angular velocity is fitted by using a polynomial of order n,

$$ω = {\sum }_{i = 0}^{n} {c}_{i} {t}^{i} , n \leq N - 1$$

or angular increments and the angular velocity are expressed as Δθₜ_{ₖ}=∫ₜ_{_{k−1}}^{t}^{ₖ}ωdt;

Step 2, iteratively calculating a Rodrigues vector by using the fitted polynomial function of angular velocity and the Rodrigues vector integral equation, wherein the step 2 comprises performing the iterative calculation, by substituting the fitted polynomial function of the angular velocity into the Rodrigues vector integral equation, until a convergence condition is satisfied or a predetermined value of maximum times of iteration is reached, wherein the integral equation g is expressed as follows:

$${g}_{j + 1} = {\int }_{0}^{t} ( I + \frac{1}{2} {g}_{j} \times + \frac{1}{4} {g}_{j} {g}_{j}^{T} ) ω dt ,$$

wherein the initial value g₀=0;

Step 3, obtaining an attitude change over the time interval in terms of quaternion according to the final iterative result of the Rodrigues vector in accordance with an equation:

$$q = \frac{2 + g}{\sqrt{4 + {\vert g \vert}^{2}}} \text{;}$$

In one embodiment, the gyroscope measurement value takes the form of either angular velocity or an angular increment.

In one embodiment, the Step 1 includes:

with respect to N angular velocity measurement values ωₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

In one embodiment, the Step 1 includes:

with respect to N angular increment values Δθₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

In one embodiment, the Step 2 includes:

performing the iterative calculation, by substituting the fitted polynomial function of the angular velocity into the Rodrigues vector integral equation, until a convergence condition is satisfied or a predetermined value of maximum times of iteration is reached.

In one embodiment, the Step 1 includes:

with respect to N angular velocity measurement values ωₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

In one embodiment, the Step 1 includes:

with respect to N angular increment values Δθₜ_{ₖ}, k=1,2, . . . N at time kₖ, fitting the polynomial function of the angular velocity by using a polynomial of order less than N−1; or, fitting the polynomial function of the angular velocity according to Chebyshev polynomial.

In one embodiment Step 2 includes:

performing the iterative calculation, by substituting the fitted polynomial function of the angular velocity into the Rodrigues vector integral equation, until a convergence condition is satisfied or a predetermined value of maximum times of iteration is reached.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

Other features, objects, and advantages of the present disclosure will become apparent by reading the following detailed description to the non-limited embodiments with reference to the drawings.

FIG. 1 is a flowchart of the attitude computation method of a rigid body based on function iterative integration according to the present disclosure;

FIG. 2 illustrates an exemplary rigid body with an affixed inertial measurement unit, in accordance with an embodiment of the present invention.

FIG. 3 illustrates an exemplary flowchart for a method of implementing a motion trajectory generator, in accordance with an embodiment of the present invention.

FIG. 4 illustrates an exemplary block diagram of an inertial navigation system in which the present method can serve as a key component, in accordance with an embodiment of the present invention.

### DETAILED DESCRIPTION

The disclosure will now be described in details in connection with the embodiments. The following embodiments are intended for facilitating those skilled in the art to understand the present invention, instead of limiting the present invention in any way. It should be noted that a number of variations and modifications may be made by those skilled in the art without departing from the inventive concept, all of which fall within the scope of protection of the present disclosure.

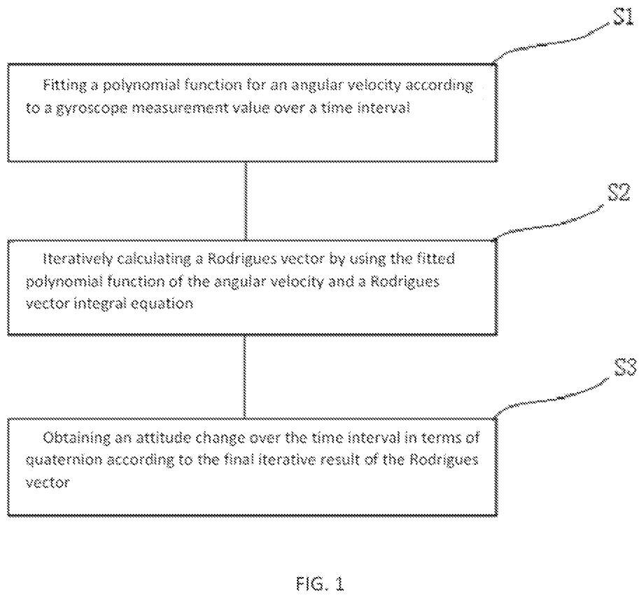

As shown in FIG. 1, the attitude computation method of a rigid body based on function iterative integration according to the present disclosure specifically comprises the following steps:

(1) to fit a polynomial function of angular velocity according to gyroscope measurements over a time interval [0 t];

The gyroscope measurement is generally given by two forms: angular velocity and angular increment, which will be respectively described as follows:

with respect to N angular velocity measurements ωₜ_{ₖ}, k=1,2, . . . N at time tₖ, the polynomial function of angular velocity is fitted by using a polynomial of order n (less than or equal to N−1) , that is,

$$ω = {\sum }_{i = 0}^{n} {c}_{i} {t}^{i} , n \leq N - 1 \qquad ( 1 )$$

where the coefficient cᵢ may be determined by solving the following equation:

$${A}_{ω} [ \begin{matrix}{c}_{0}^{T} \\ {c}_{1}^{T} \\ ⋮ \\ {c}_{n}^{T}\end{matrix} ] • [ \begin{matrix}1 & {t}_{1} & … & {t}_{1}^{n} \\ 1 & {t}_{2} & … & {t}_{2}^{n} \\ ⋮ & ⋮ & ⋮ & ⋮ \\ 1 & {t}_{N} & … & {t}_{N}^{n}\end{matrix} ] [ \begin{matrix}{c}_{0}^{T} \\ {c}_{1}^{T} \\ ⋮ \\ {c}_{n}^{T}\end{matrix} ] = [ \begin{matrix}{ω}_{{t}_{1}}^{T} \\ {ω}_{{t}_{2}}^{T} \\ ⋮ \\ {ω}_{{t}_{N}}^{T}\end{matrix} ] \qquad ( 2 )$$

where [c₀ c₁ . . . cₙ]^{T}=A_{ω}⁻¹[ωₜ_{₁} ωₜ_{₂} . . . ωₜ_{_{N}}]^{T}. When n<N−1, A_{ω}⁻¹ stands for the matrix inverse in the meaning of least squares, A_{ω}⁻¹=(A_{ω}^{T}A_{ω})⁻¹A_{ω}^{T}, and it also applies to the following equation, where T stands for a uniform sampling time interval.

Similarly, with respect to N angular increments Δθₜ_{ₖ}, k=1,2, . . . N at time tₖ, the polynomial function of angular velocity is fitted by using a polynomial of order n (less than or equal to N−1). The relationship between the angular increments and the angular velocity could be expressed as Δθₜ_{ₖ}=∫ₜ_{_{k−1}}^{t}^{ₖ} ωdt

$${A}_{θ} [ \begin{matrix}{c}_{0}^{T} \\ {c}_{1}^{T} \\ ⋮ \\ {c}_{n}^{T}\end{matrix} ] • [ \begin{matrix}{t}_{1} & \frac{{t}_{1}^{2}}{2} & … & \frac{{t}_{1}^{n + 1}}{n + 1} \\ {t}_{2} - {t}_{1} & \frac{{t}_{2}^{2} - {t}_{1}^{2}}{2} & … & \frac{{t}_{2}^{n + 1} - {t}_{1}^{n + 1}}{n + 1} \\ ⋮ & ⋮ & ⋮ & ⋮ \\ {t}_{N} - {t}_{N - 1} & \frac{{t}_{N}^{2} - {t}_{N - 1}^{2}}{2} & … & \frac{{t}_{N}^{n + 1} - {t}_{N - 1}^{n + 1}}{n + 1}\end{matrix} ] [ \begin{matrix}{c}_{0}^{T} \\ {c}_{1}^{T} \\ ⋮ \\ {c}_{n}^{T}\end{matrix} ] = [ \begin{matrix}Δ {θ}_{{t}_{1}}^{T} \\ Δ {θ}_{{t}_{2}}^{T} \\ ⋮ \\ Δ {θ}_{{t}_{N}}^{T}\end{matrix} ] \qquad ( 3 )$$

That is, [c₀ c₁ . . . cₙ]^{T}=A_{θ}⁻¹[Δθₜ_{₁} Δθₜ_{₂} . . . Δθₜ_{_{N}}]^{T}.

When the order of the fitted polynomial is large, there may be a numerical instability problem in calculating A_{ω}⁻¹ or A_{θ}⁻¹. In order to improve the robustness of calculation, the polynomial function (1) of the angular velocity may also be fitted based on the Chebyshev polynomial;

(2) to iteratively calculate the Rodrigues vector by using the fitted polynomial function of angular velocity and the Rodrigues vector integral equation.

The iterative integral equation of the Rodrigues vector g is expressed as follows:

$${g}_{j + 1} = {\int }_{0}^{t} ( I + \frac{1}{2} {g}_{j} \times + \frac{1}{4} {g}_{j} {g}_{j}^{T} ) ω dt \qquad ( 4 )$$

where the initial value g₀=0. The fitted polynomial function (1) of the angular velocity is substituted into the above formula, and the iterative calculation is performed until a convergence condition is satisfied or a predetermined value of maximum times of iteration is reached.

(3) to obtain the attitude quaternion relative to the start end of the time interval according to the final iterative result of the Rodrigues vector.

$$q = \frac{2 + g}{\sqrt{4 + {\vert g \vert}^{2}}} \qquad ( 5 )$$

The relationship between the length t of the time interval and the number of samples N as well as the uniform sampling time interval T is expressed as t=N×T. For attitude computation on a longer time interval, it could be divided into several small time intervals, and the iterative calculation is performed in turn within each sub-interval.

In principle, the attitude computation method based on function iterative integration according to the present disclosure is also applicable to other three-dimensional attitude parameters (such as the rotation vector), if a certain degree of accuracy loss is acceptable. In such situation, steps 2) and 3) may be adjusted accordingly as follows:

(4) to iteratively calculate the rotation vector by using the fitted polynomial function of angular velocity and the rotation vector integral equation.

The iterative rotation vector integral equation g is expressed as follows:

gⱼ₊₁=∫ₒⁱ(1+½gⱼ×+ 1/12(gⱼ×)²)ωdt (6)

wherein, the initial value g₀=0. The fitted polynomial function (1) of the angular velocity is substituted into the above formula, and the iterative calculation is performed until a convergence condition is satisfied or a predetermined value of maximum times of iteration is reached.

(5) to obtain the attitude quaternion relative to the start end of the time interval according to the final iterative result of the rotation vector.

$$q = cos \frac{\vert g \vert}{2} + \frac{g}{\vert g \vert} sin \frac{\vert g \vert}{2} \qquad ( 7 )$$

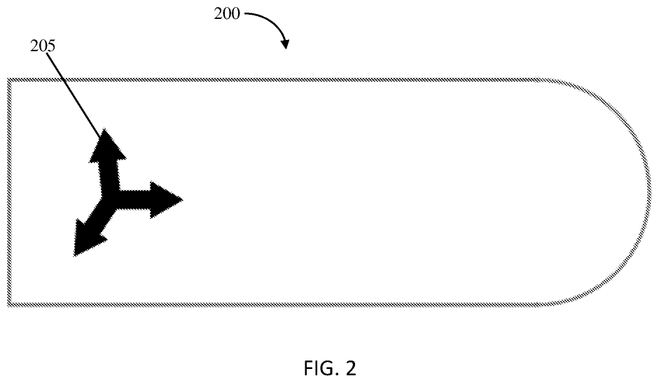

As shown in FIG. 2, taken as an embodiment in the navigation field, a triad of gyroscopes, or inertial measurement unit 205 including a triad of gyroscopes, is rigidly fixed on rigid body 200, such as, without limitation, a submarine, a highly dynamic projectile, a vehicle, etc., to measure the angular motion of rigid body 200. Eqs. (1)-(5) may be used with the gyroscope measurements to acquire the attitude of rigid body 200. Specifically, the polynomial function of angular velocity is reconstructed from the gyroscope angular velocity measurements by using eqs. (1) and (2) or gyroscope angular increment measurements by using eqs. (1) and (3). Subsequently, the attitude of rigid body 200 is iteratively calculated by using eqs. (4) and (5). The present embodiment may be several orders of magnitude more accurate than current attitude algorithms For example, rigid body 200 may be subject to a classical attitude coning motion with a 10-degree coning angle and 0.74 π coning frequency. At a gyroscope sampling rate of 100 Hz, the principal angle drift error of the present embodiment in one second is about 10⁻¹⁵ degrees, but that of the mainstream 2-sample attitude algorithm is as large as 10⁻⁵ degrees. To achieve the extremely high accuracy, the disclosed attitude calculation method by function iterative integration is founded on exact Rodrigues vector kinematics, in contrast to the simplified rotation vector differential equation relied upon by conventional attitude algorithms In summary, the present invention may produce a higher-accuracy attitude information for rigid bodies, without changing gyroscope hardware. With a higher-accuracy attitude result, projectiles may reach targets more precisely and submarines may safely navigate under the sea for a longer time.

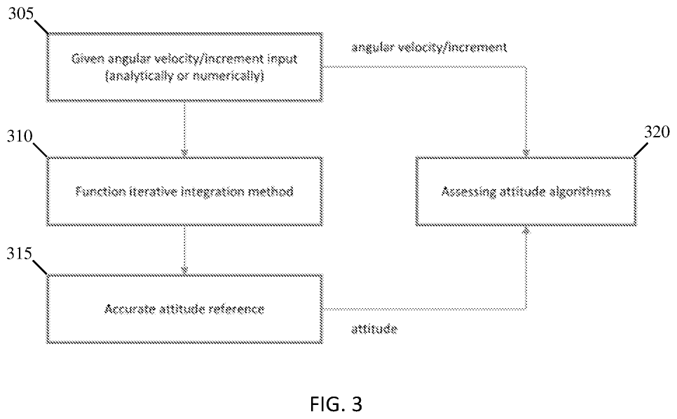

As shown in FIG. 3, another embodiment relates to a motion trajectory generator for numerical simulation given angular velocity or angular increment input (analytically or numerically). In traditional trajectory generation, an analytical attitude reference is given (e.g., the above-mentioned classical attitude coning motion) and used to derive the corresponding angular measurements. Both the attitude reference and the angular measurements are then employed to assess attitude calculation algorithms via the motion trajectory generator. In view of the super high-accuracy attitude calculation result of the disclosed function iterative integration method, the trajectory generator may be achieved by directly using the given angular velocity or angular increment measurement to produce an accurate attitude reference. In this regard, motion trajectory that is appliable for assessing attitude algorithms may be considerably enriched by the function iterative integration method of the present embodiment. In a step 305, the angular velocity or the angular velocity increment may be obtained from a triad of gyroscopes. In a step 310, the angular velocity or the angular increment may be input into the function iterative integration method of the present embodiment, as described above with reference to Equations. (1)-(5). In a step 315, an accurate attitude reference may be obtained. In a step 320, the attitude from step 315 and the angular velocity/increment from step 305 may be used in assessing attitude algorithms

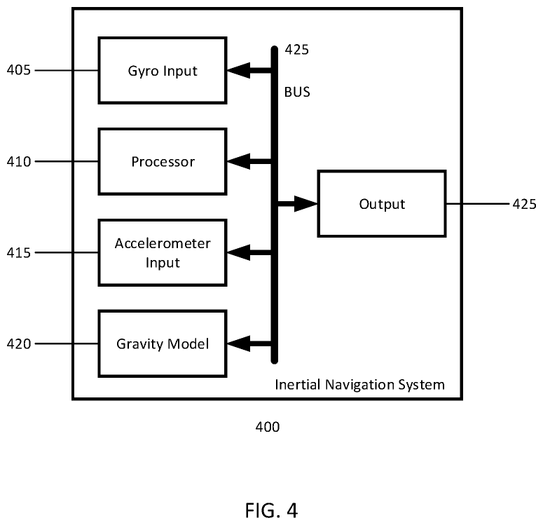

With reference to FIG. 4, the methods and systems of the present disclosure can also be implemented as a key component in an inertial navigation system 400 to provide additional velocity and position information of rigid body for reporting or vehicle controlling purposes through output interface 425. The gyroscope measurements received from gyro input 405 may be calculated using Eqs. (1)-(5) by the processor 410 to produce accurate attitude of rigid body. The obtained attitude result could be shared with interval bus 425 and further used with both acceleration measurements from the accelerometer input 415 and the gravitational acceleration calculated from gravity model 420, to produce velocity and position information by the processor 410 as well. The processor 410 could be a general computer CPU or a dedicated hardware processing unit such as ARM or FPGA. The obtained accurate attitude, possibly together with velocity and position, could be emploited to control or navigate the vehicle within which an inertial navigation system is fixed, or fed to other sub-vehicles onboard the vehicle for navigation purposes after they leave the vehicle, like a missile onboard a submarine or carrier. The gyro input 405, the accelerometer input 415 and the output 425 could be internet connections that receive gyroscope/accelerometer measurements from or send attitude/veolcity/position results to remote users, who employ the inertial navigation system 400 as a remote testbed to process their gyroscope/accelerometer measurements locally collected.

Specific embodiments of the present disclosure are described as above. It is understood that the present disclosure is not limited to the above specific embodiments, and those skilled in the art may make various of modification and changes within the scope of the appended claims, which will not impact the essential contents of the present disclosure. The embodiments and the features thereof in the present disclosure may be combined in any way.

What is claimed is:

1. A system, comprising:
a rigid body; and
an inertial navigation system attached to the rigid body;
wherein the inertial navigation system comprises a triad of gyroscopes, one or more processors, and a memory storing program instructions for calculating the attitude of the rigid body, wherein execution of the program instructions by the one or more processors causes the one or more processors to carry out the following steps:
Step 1, fitting a polynomial function of angular velocity according to gyroscope measurements, from a triad of gyroscopes, over a time interval, wherein the polynomial function of the angular velocity is fitted by using a polynomial of order n,
$$ω = {\sum }_{i = 0}^{n} {c}_{i} {t}^{i} , n \leq N - 1$$
or angular increments and the angular velocity are expressed as Δθₜ_{ₖ}=∫ₜ_{_{k−1}}^{t}^{ₖ}ωdt;
Step 2, iteratively calculating a Rodrigues vector by using the fitted polynomial function of angular velocity and the Rodrigues vector integral equation, wherein the step 2 comprises performing the iterative calculation, by substituting the fitted polynomial function of the angular velocity into the Rodrigues vector integral equation, until a convergence condition is satisfied or a predetermined value of maximum times of iteration is reached, wherein the integral equation g is expressed as follows: gⱼ₊₁=∫₀^{t}(1+½gⱼ×+¼gⱼgⱼ^{T})ωdt, wherein the initial value g₀=0;
Step 3, obtaining an attitude change over the time interval in terms of quaternion according to the final iterative result of the Rodrigues vector in accordance with an equation:
$$q = \frac{2 + g}{\sqrt{4 + {\vert g \vert}^{2}}} \text{;}$$

2. The system of claim 1, wherein the gyroscope measurement value takes the form of either angular velocity or an angular increment.

3. The system of claim 1, wherein the Step 1 comprises:
with respect to N angular velocity measurement values ωₜ_{ₖ}, k=1,2, . . . N at time tₖ fitting the polynomial function of the angular velocity by using a polynomial of order less than N−1; or, fitting the polynomial function of the angular velocity according to Chebyshev polynomial.

4. The system of claim 1, wherein the Step 1 comprises:
with respect to N angular increment values Δθₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

5. The system of claim 1, wherein the Step 2 comprises:
performing the iterative calculation, by substituting the fitted polynomial function of the angular velocity into the Rodrigues vector integral equation, until a convergence condition is satisfied or a predetermined value of maximum times of iteration is reached.

6. The system of claim 2, wherein the Step 1 comprises:
with respect to N angular velocity measurement values ωₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

7. The system of claim 2, wherein the Step 1 comprises:
with respect to N angular increment values Δθₜ_{ₖ}, k=1,2, . . . N at time tₖ, fitting the polynomial function of the angular velocity by using a polynomial of order less than N−1; or, fitting the polynomial function of the angular velocity according to Chebyshev polynomial.

8. The system of claim 6, wherein the Step 2 comprises:
performing the iterative calculation, by substituting the fitted polynomial function of the angular velocity into the Rodrigues vector integral equation, until a convergence condition is satisfied or a predetermined value of maximum times of iteration is reached.
